(19) United States
(12) Patent Application Publication
(10) Pub. No.: US 2012/0090941 A1
(43) Pub. Date: Apr. 19, 2012

(54) CLUTCH SLEEVE FOR A SHIFT CLUTCH AND SHIFT CLUTCH

(75) Inventors: Joerg APPELSHAEUSER, Mainz (DE); Viktor WERWEIN, Bensheim (DE); Marc THORAUSCH, Ruesselsheim (DE)

(73) Assignee: GM GLOBAL TECHNOLOGY OPERATIONS LLC, Detroit, MI (US)

(21) Appl. No.: 13/270,425

(22) Filed: Oct. 11, 2011

(30) Foreign Application Priority Data
Oct. 12, 2010 (DE) 102010048344.3

(51) Int. Cl. F16D 13/22; F16D 13/00

(52) U.S. Cl. 192/53.3; 192/108

(57) ABSTRACT

A clutch sleeve is provided for a shift clutch having a synchronizing device, which includes, but is not limited to a clutch body, which is connected in a rotationally-fixed manner to a gear wheel mounted so it is rotatable on a shaft and has coupling teeth and a friction cone as well as a synchronizing ring having a counter cone and blocking teeth, and which has shift teeth, the clutch sleeve having shift teeth, which are designed in such a manner that a first group of the shift teeth cooperates with the blocking teeth until a synchronized speed is reached and a second group of the shift teeth engages in the coupling teeth after the synchronized speed is reached.

### CROSS-REFERENCE TO RELATED APPLICATION

This application claims priority to German Patent Application No. 10 2010 048 344.3, filed Oct. 12, 2010, which are incorporated herein by reference in their entirety.

### TECHNICAL FIELD

The technical field relates to a clutch sleeve for a shift clutch and a shift clutch, in particular of a shift transmission for a motor vehicle, with the aid of which the shifting quality can be improved.

### BACKGROUND

A shift clutch having a synchronizing device comprises a clutch body, which is connected in a rotationally-fixed manner to a gear wheel mounted so it is rotatable on a shaft and has coupling teeth and a friction cone. Furthermore, it has a synchronizing ring having a counter cone and blocking teeth as well as a sleeve, which has shift teeth, at least a part of which cooperate via frontal inclined faces with blocking faces on the blocking teeth. The sleeve is guided so it is axially displaceable on a sleeve guide, which is connected in a rotationally-fixed manner to the shaft.

In shift transmissions, which are shifted under traction force interruption, i.e., an input shaft is disconnected by a clutch from a drive machine during the shift procedure, the respective gear can be engaged using a shift clutch in such a manner that the gear wheel revolving on the shaft that is associated with the gear is coupled to the shaft. The shifted gear determines the transmission ratio and therefore the speed ratio between the input shaft and an output shaft of the transmission. The freely revolving gear wheels, which are continuously engaged, of the remaining gears run at a speed corresponding to their transmission ratio, and the gear wheels of a lower reduction stage, which corresponds to a higher gear, run more rapidly than those of a higher reduction stage.

In order that the shift teeth of the sleeve can engage in the coupling gearing of the clutch body, the parts to be coupled must previously be brought to an equal speed. The synchronizing device is used for this purpose, which essentially consists of the friction cone on the clutch body and the synchronization ring having its counter cone and the blocking teeth. The synchronization ring revolves with the sleeve, but can rotate in relation thereto by a limited angle.

In particular at lower temperatures, at which the transmission oil has a higher viscosity, the transmission oil strongly decelerates the parts which are decoupled from the drive during the shift procedure, so that the initially more rapidly running gear wheel is decelerated by both the synchronizing device and also by the higher oil viscosity. It therefore already passes through the synchronizing point, at which the synchronizing ring rotates in relation to the clutch sleeve in the opposite direction, after a short time, whereby cold scratching can occur. Designing the shift teeth asymmetrically is therefore proposed in the publication DE 3444670 C1.

At least one object is to specify a clutch sleeve for a shift clutch having a synchronizing device and such a shift clutch, which is simply and effectively designed and provides an improved shift feeling. In addition, other objects, desirable features, and characteristics will become apparent from the subsequent summary and detailed description, and the appended claims, taken in conjunction with the accompanying drawings and this background.

### SUMMARY

According to one embodiment, a clutch sleeve for a shift clutch having a synchronizing device is specified, which comprises a clutch body, which is connected in a rotationally-fixed manner to a gear wheel mounted so it is rotatable on a shaft and has coupling teeth and a friction cone, and a synchronizing ring having a counter cone and blocking teeth. The clutch sleeve has shift teeth. A first group of the shift teeth of the clutch sleeve are designed in such a manner that they cooperate with the blocking teeth until a synchronized speed is reached. A second group of the shift teeth of the clutch sleeve are designed in such a manner that they engage in the coupling teeth after the synchronized speed is reached. The shift clutch can be used in a manual transmission.

At least one of the basic ideas is therefore that a functional separation occurs between the synchronizing and the meshing. This is ensured since the first group of the shift teeth of the clutch sleeve is exclusively provided for the synchronizing, while the second group of the shift teeth of the clutch sleeve are only used for the meshing, because of which they can be optimized for their respective function.

Such a clutch sleeve has the advantage that the shift clutch has an improved shifting ability, since the occurrence of upshift scratching on shift transmissions after the buildup of differential speeds due to internal transmission losses is minimized. The shifting ability during downshifting simultaneously remains unimpaired. Because of the lesser tendency toward shift scratching, the tooth tips are also protected and therefore have a longer durability, i.e., the system additionally gains robustness. The functional separation can be ensured by the shape of the teeth. For example, the teeth of the first group can have a different shape than the teeth of the second group.

In one embodiment, the second group of the shift teeth is oriented to engage in the coupling teeth, while the first group of the shift teeth cooperates with the blocking teeth. Furthermore, the first group of the shift teeth can rotate further at the same speed as the second group of the shift teeth, while the second group of the shift teeth engages in the coupling teeth.

A better functional separation between synchronizing and meshing can thus be ensured and the teeth can be further optimized for their respective function. The first group of the shift teeth only assumes the task of synchronizing, while the second group of the shift teeth is exclusively provided for meshing. In this manner, the possibility of a tooth double engagement in the coupling teeth can be avoided, whereby the shifting quality of the shift clutch is increased further, since the contact of the tooth tips of the teeth of shift gearing and clutch gearing on the gear first occurs as soon as the synchronization is completely finished. This also has a positive effect in particular in the case of a high viscosity of the transmission oil, which is connected with low temperatures, whereby the occurrence of upshift scratching can be prevented.

In a further embodiment, the teeth of the first group of the shift teeth are designed as axially shorter than the teeth of the second group of the shift teeth. In this manner, the tooth tips of the second group of the shift teeth can rather engage in the intermediate spaces between the coupling teeth, whereby blocking during meshing is precluded and a tooth double engagement in the coupling gearing can be prevented. The functional separation during meshing can thus be ensured, since only the teeth of the second group of the shift teeth completely plunge into the coupling gearing.

Furthermore, the roof faces of the teeth of the second group of the shift teeth can be designed as asymmetrical. Since the second group of the shift teeth is exclusively used for meshing and not for synchronizing, the front and the rear roof faces of the teeth of the second group of the shift teeth can be designed having different slopes, i.e., the acting forces can be controlled in such a manner that during the entry movement, the clutch sleeve is only opposed with a comparatively low resistance by the synchronizing ring, the engagement of the gear is therefore not blocked, and more rapid shifting is made possible. In this case, the roof faces of the coupling teeth are preferably designed as asymmetrical in the same manner, so that in the engagement position, the apex between the roof faces of the teeth of the second group of the shift teeth is approximately symmetrical to the roof faces on two adjacent teeth of the coupling gearing, whereby different rotation routes for the clutch body during meshing can be avoided. The roof faces of the teeth of the second group of the shift teeth can be designed as triangular or trapezoidal. The roof faces of the asymmetrically tapered teeth of the second group of the shift teeth are therefore not subject to strict dimensional guidelines, because of which they are cost-effectively producible and easily replaceable, without having to make use of special productions.

In a further embodiment, the front roof face in the running direction of the teeth of the second group of shift teeth has a different roof angle than the rear roof face in the running direction. In this case, in the running direction means in the rotational direction of the shift teeth. In this manner, a rejection of the clutch sleeve, which is perceived as annoying by the driver during shifting, may be avoided, since the time, during which the teeth of the second group of the shift teeth can engage with the coupling gearing, is increased. The roof faces of the shift gearing and the clutch gearing can also easily slide against one another when they strike one another because of different rotational direction relationships.

The roof angle of the front roof face in the running direction of the teeth of the second group of the shift teeth can thus be approximately 0° to approximately 25°. With such an angle range, a possible momentum of the coupling gearing on the gear wheel only acts on the clutch sleeve in the running direction of the two parts in the case of a further differential speed of both parts because of an excessively slow shift or an excessively high viscosity of the transmission oil at low temperatures, for example, without a rejection of the clutch sleeve occurring, which would be perceived as annoying by the driver on the shift lever, whereby the shift feeling during meshing is improved.

The roof angle of the rear roof face in the miming direction can be approximately 45°. Such an angle helps the roof faces of the teeth of shift teeth and clutch teeth to be able to slide easily against one another, when they strike one another because of the different rotational direction relationships, whereby reliable meshing is ensured and the upshifting or downshifting is not impaired or worsened. In a further embodiment, the roof faces of the teeth of the second group of the shift teeth are designed as rectangular or round. Components designed in this manner can be used independently of the rotational direction. The shifting capability during downshifting thus also remains unimpaired. Manifold parts and incorrect installation can thus also be avoided.

The roof faces of the teeth of the first group of the shift teeth can further be designed as symmetrical. Since the roof faces of the teeth of the first group of the shift teeth, which are exclusively used for synchronizing, are designed as symmetrical, they can be used for different running directions. Manifold parts and incorrect installation can thus be avoided and the shifting ability during downshifting also remains unimpaired.

Furthermore, the roof angles of the symmetrical roof faces of the teeth of the first group of the shift teeth can be approximately 40° to approximately 60°. The teeth of the first group of the shift teeth, which are exclusively used for synchronizing, can thus be optimized for their function. The friction faces resulting through the roof faces of the blocking teeth can thus be formed in such a manner to minimize the force required for the engagement. Such a roof angle therefore ensures that the parts to be coupled are previously brought to an equal speed, a sufficient axial force is exerted on the synchronizing ring, as soon as the inclined roof faces of the first group of the shift teeth strike on the blocking faces of the blocking teeth. Teeth having such roof angles can also be produced simply and cost-effectively.

In a further embodiment, the roof faces of the teeth of the first group of the shift teeth are designed as asymmetrical. Predominantly the front roof face in the running direction of the teeth of the first group of the shift teeth thus has a greater axial extension than the rear roof face in the running direction. The occurrence of cold scratching can thus be reduced further. It is thus ensured that in spite of an instantaneous synchronization between clutch sleeve and synchronizing ring, the clutch sleeve cannot be readily engaged with the gearing of the synchronizing ring, but rather the teeth of the first group of the shift teeth engage with the blocking faces of the synchronizing ring in such a manner that the clutch body is carried along by the synchronizing ring against the braking action of the oil, which has a high viscosity at low temperatures, and is forced into synchronization with the clutch sleeve.

Furthermore, the teeth of the second group of the shift teeth can be axially advanced in relation to the teeth of the first group of the shift teeth on the clutch sleeve. A possible double engagement, i.e., a contact of the roof faces of the teeth of the shift gearing and the clutch gearing on the gear wheel before the synchronization is completely ended, can thus be avoided. This results in a further increased shifting quality. It can also be ensured in this manner that only the second group of the shift teeth fully engages in the coupling gearing, because of which the respective group of the shift teeth can be optimized for their function, and a reliable functional separation between synchronizing and meshing can be ensured.

In a further embodiment, the synchronizing ring only has blocking teeth at the points at which the teeth of the first group of the shift teeth engage. It is thus ensured that only the first group of the teeth of the shift teeth cooperates with the blocking teeth, which are provided for synchronizing. The shift teeth of the second group, which are exclusively used for meshing, can therefore engage easily and in a short time in the gaps between adjacent teeth of the clutch teeth, whereby the shifting quality is increased. The teeth can also be designed in such a manner that they are optimized for their respective function and a reliable functional separation between synchronizing and meshing is ensured.

In summary, it can be stated that a shift clutch having a synchronizing device is specified by the embodiments, which is designed in such a manner that a functional separation occurs between the synchronizing and the meshing. Since a first group of the teeth of the shift teeth is exclusively used for synchronizing and a second group of the shift teeth is exclusively provided for meshing, the teeth can be optimized for their respective function. The teeth of the second group of the shift teeth can thus be formed asymmetrically and/or having different roof angles, whereby the occurrence of cold scratching because of differential speeds, caused by internal transmission losses, can be prevented. The roof angle of the roof faces of the teeth of the first group of the shift teeth can be formed in such a manner that even at low temperatures, at which the transmission oil has a higher viscosity; a sufficient axial force is exerted on the synchronizing ring to ensure effective synchronization.

The functional separation can be ensured in that the teeth of the second group of the shift teeth are designed as axially longer than the teeth of the second group of the shift teeth, or are axially advanced on the clutch sleeve, whereby a double engagement in the coupling teeth is simultaneously avoided. The functional separation can also be performed in that the synchronizing ring only has blocking teeth at the points at which the teeth of the first group of the shift teeth engage. Furthermore, the roof faces of the teeth of the first and second shift groups are not subject to strict dimensional guidelines, because of which they are producible simply and cost-effectively and are easy to replace. Manifold parts can also be avoided in this manner.

### BRIEF DESCRIPTION OF THE DRAWINGS

The present invention will hereinafter be described in conjunction with the following drawing figures, wherein like numerals denote like elements, and:

FIG. 1 shows a schematic perspective cross-sectional view of a transmission part having a shift clutch according to an embodiment;

FIG. 2A to FIG. 2F show partial steps of unrolling of shift gearing, blocking gearing, and coupling gearing in a comparison synchronizing device;

FIG. 3A to FIG. 3F show partial steps of unrolling of shift gearing, blocking gearing, and coupling gearing in a synchronizing device according to one embodiment;

FIG. 4A to FIG. 4D show schematic cross sections of the teeth of the second group of the shift teeth according to different embodiments; and

FIG. 5A and FIG. 5B show schematic cross sections of the teeth of the first group of the shift teeth according to different embodiments.

### DETAILED DESCRIPTION

The following detailed description is merely exemplary in nature and is not intended to limit application and uses. Furthermore, there is no intention to be bound by any theory presented in the preceding background or summary or the following detailed description.

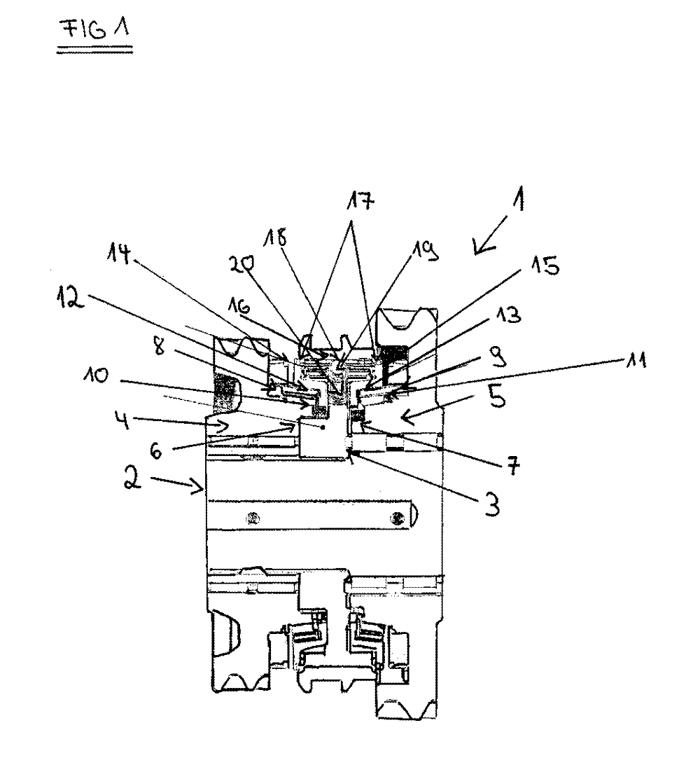

FIG. 1 shows a schematic perspective cross-sectional view of a transmission part 1 having a shift clutch according to one embodiment. A shaft 2 is shown, which is fastened on a guide sleeve 3 in a rotationally-fixed and axially non-displaceable manner by means of teeth. In addition to the guide sleeve 3, gear wheels 4, 5 are mounted so they are rotatable on the shaft 2 on both sides, which have an axial extension 6, 7 on their side facing toward the guide sleeve 2, on each of which a clutch body 8, 9 is placed. These engage with internal gearing in external gearing on the extensions 6, 7, so that they are connected in a rotationally-fixed manner to the gear wheels 4, 5 assigned thereto. Furthermore, the clutch bodies 8, 9 each have a conical face 10, 11, each of which forms a counter cone for a synchronizing ring 12, 13. The clutch bodies 8, 9 also each have external gearing, the coupling gearing 14, 15, on the periphery of a section adjoining the conical faces 10, 11. Furthermore, FIG. 1 shows a clutch sleeve 16 having a shift gearing 17, which engages in the coupling gearing 14, 15. In the idle position thereof, the clutch sleeve 16 is situated centrally to the central plane of the guide sleeve 3 and has a central ring groove 18, in which detent balls 19 engage. The detent balls 19 are situated, together with the compression springs 20 that load them, in radial holes of the guide sleeve 3.

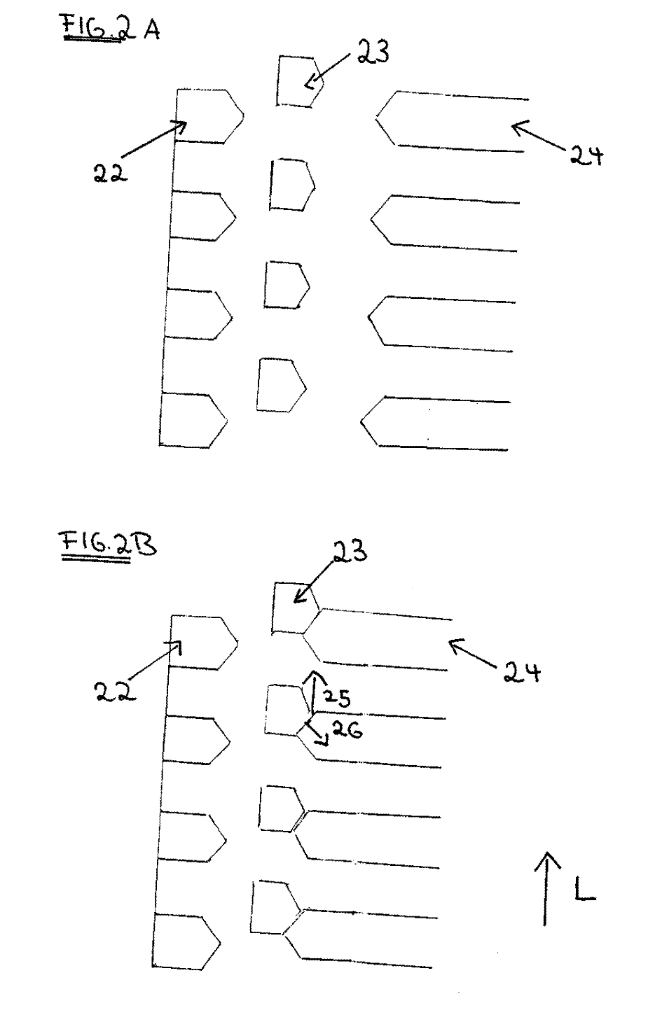

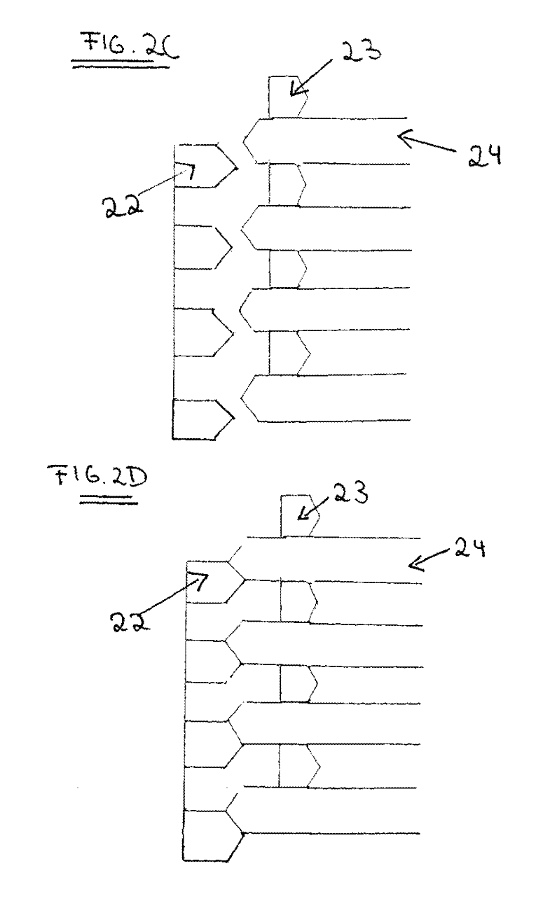

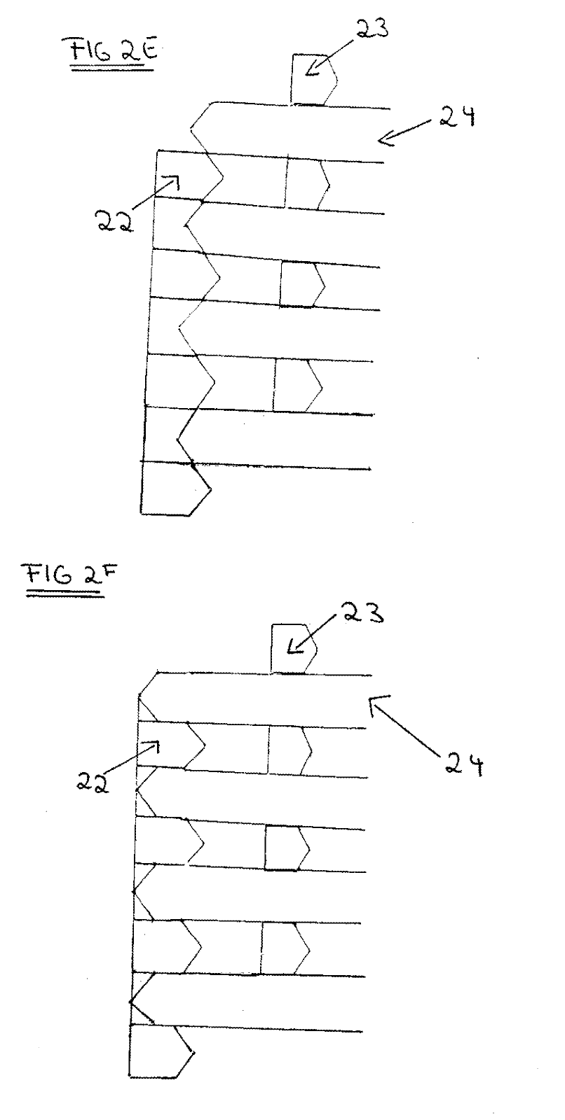

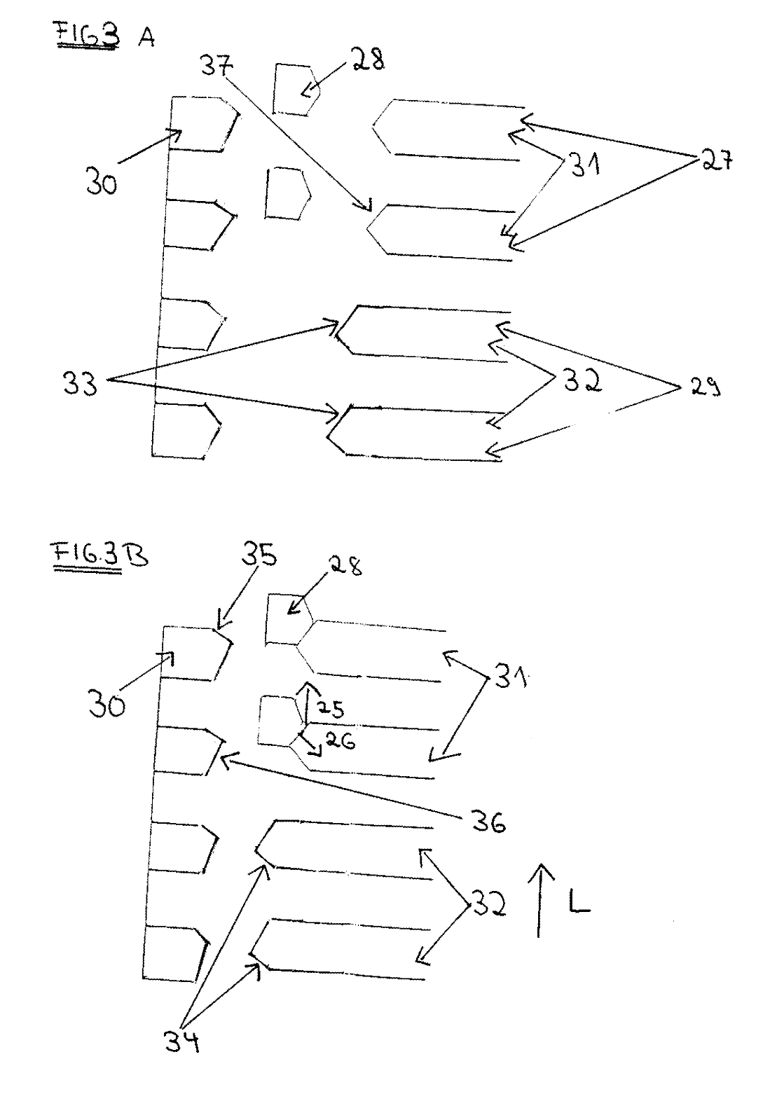

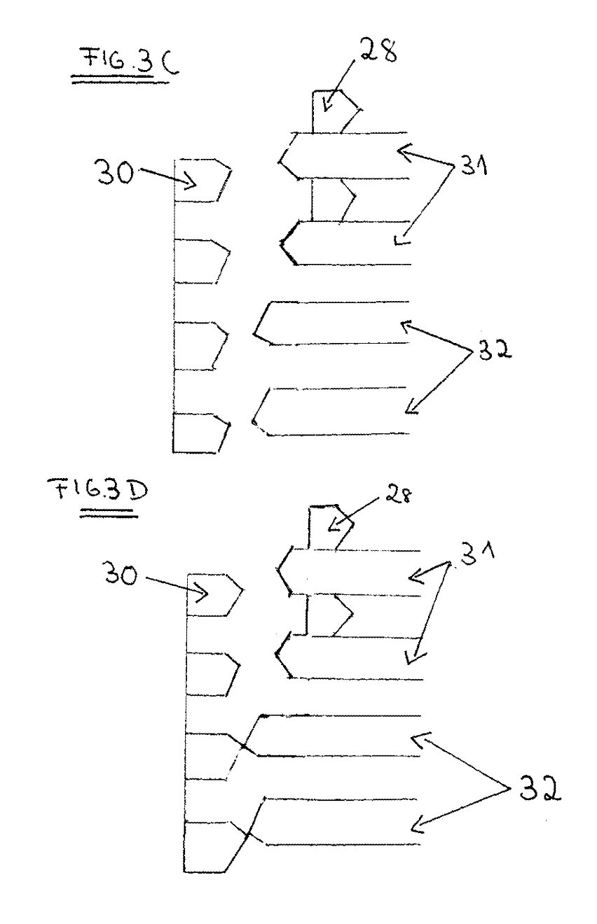

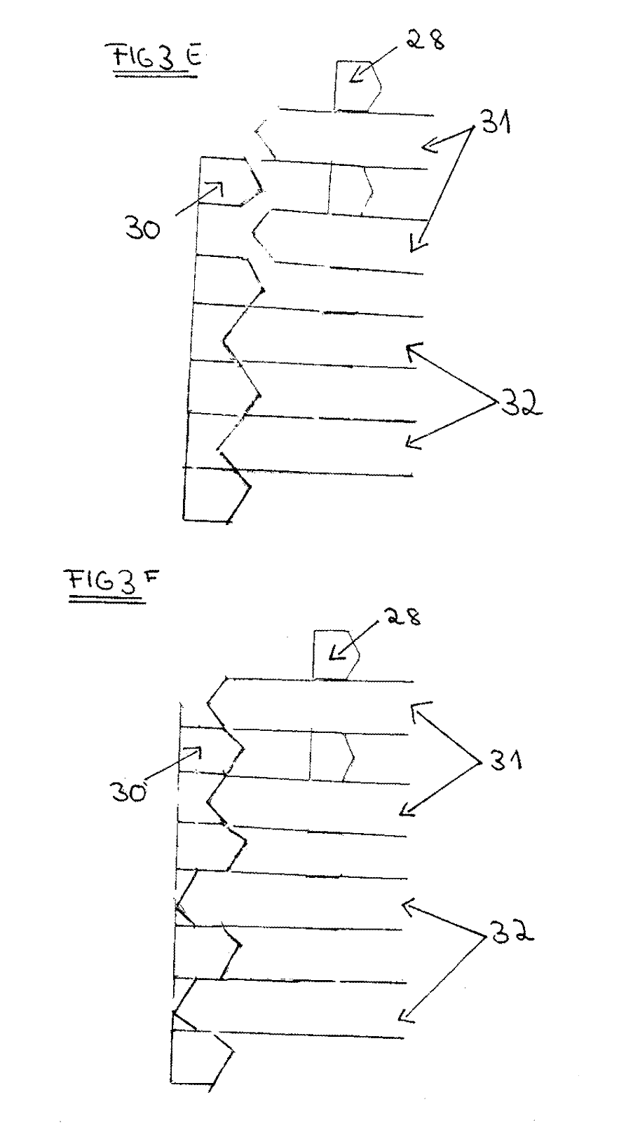

The engagement of a specific gear is now performed in a known manner in that the clutch sleeve 16 is engaged by axial displacement with the coupling gearing 14, 15 of an adjacent gear wheel 4, 5, whereby a rigid connection is produced between the shaft 2 and the gear wheel 4, 5 engaged with the clutch sleeve 16. The function of the synchronizing device will be explained in greater detail hereafter based on FIG. 2A to FIG. 2F and FIG. 3A to FIG. 3F. These show in comparison partial steps of unrolling of shift gearing 17, blocking gearing, and coupling gearing 14, 15 using a conventional synchronizing device (FIG. 2A to FIG. 2F) and a synchronizing device according to an embodiment (FIG. 3A to FIG. 3F).

FIGS. 2A to 2F show partial steps of unrolling of shift gearing 17, blocking gearing, and coupling gearing 14, 15 using a comparison synchronizing device. Coupling teeth 22, blocking teeth 23 of the synchronizing ring 12, 13, and shift teeth 24 of the clutch sleeve 16 are shown, which cooperate with the blocking teeth 23 until a synchronized speed is reached and subsequently engage in the clutch teeth 22. FIG. 2A shows the coupling teeth 22, blocking teeth 23, and shift teeth 24 in the neutral position, during which they do not cooperate.

If the gear is now changed, because of the different transmission ratios, the parts to be coupled must previously be brought to an equal speed. The clutch sleeve 16 is moved in the direction of the gear wheel 4, 5 to be shifted, whereby the synchronizing ring having its counter cone is moved toward the cone of the clutch body 8, 9. The synchronizing ring 12, 13 rotates relative to the sleeve 16, so that the inclined faces of the shift gearing 17 strike the blocking faces of the blocking teeth 23. This is shown in FIG. 2B. The arrow provided with reference sign L symbolizes the running direction of the shift teeth 24.

An axial force is thus exerted on the synchronizing ring 12, 13. The arrow provided with reference sign 25 symbolizes the action direction of the axial force. Simultaneously, the shifting force via the inclined faces of the shift teeth 17 generates a restoring force on the synchronizing ring 12, 13. The action direction of the restoring force is symbolized via the arrow provided with reference sign 26. Upon synchronization of the parts, the restoring force predominates over the peripheral force acting on the friction faces and brings the synchronizing ring 12, 13 into a middle position, in which the sleeve 16 can be shifted through.

Under normal conditions, i.e., at temperatures for which the viscosity of the transmission oil is established, the synchronization of the parts to be coupled is maintained after the synchronization because of the mass inertia until the shifting is completely executed. At low temperatures, at which the transmission oil has a high viscosity, the transmission oil strongly decelerates the parts decoupled from the drive during the shifting procedure. If a shift is to be made from a higher reduction stage, i.e., from a lower gear, to a lower reduction stage, i.e., a higher gear, the gear wheel 4, 5 which initially runs more rapidly is decelerated by both the synchronizing device 12, 13 and also the higher oil viscosity. It therefore already passes through the synchronization point, at which the synchronizing ring 12, 13 rotates in the opposite direction in relation to the clutch sleeve 16, after a short time. In the middle position, the shifting route is briefly released and the shift teeth 24 engage through the intermediate spaces of the blocking teeth 23. This is shown in FIG. 2C. Since axial force is no longer exerted on the synchronizing ring 12, 13, the gear wheel 4, 5 to be coupled drops still more in speed, so that the shift teeth 24 of the sleeve 16, as shown in FIG. 2D, scratch past the coupling teeth 22, before they engage as shown in FIG. 2E, which results in the occurrence of cold scratching. Finally, FIG. 2F shows a state in which the shift teeth 24 are completely engaged in the coupling teeth 23, so that the gear wheel 4, 5 assigned to the clutch body 8, 9 is coupled to the shaft 2.

FIG. 3A to FIG. 3F partially show steps of unrolling of shift gearing 17, blocking gearing, and coupling gearing 14, 15 using a synchronizing device according to an embodiment. A first group of the shift teeth 27 can be recognized, which cooperate with the blocking teeth 28 until a synchronized speed is reached, and a second group of the shift teeth 29, which engage in the coupling teeth 30 after the synchronized speed is reached. Since the teeth 31 of the first group of the shift teeth 27 are only provided for synchronizing and the teeth 32 of the second group of the shift teeth 29 are exclusively used for meshing, a functional separation between the synchronizing and the meshing is ensured, so that the teeth 31, 32 can be optimized for their respective function.

In the exemplary embodiment shown in FIGS. 3A to FIG. 3F, the teeth 31 of the first group of the shift teeth 27 are designed as axially shorter than the teeth 32 of the second group of the shift teeth 29. Furthermore, the roof faces 33, 34 of the teeth 32 of the second group of the shift teeth 29 are designed as asymmetrical. The front roof face 33 in the running direction has a greater axial extension than the rear roof face 34 in the running direction. In the exemplary embodiment shown, the roof faces 33, 34 of the teeth 32 of the second group of the shift teeth 29 are further designed as triangular. The running direction is again symbolized by the arrow provided with reference sign L. The synchronizing ring 12, 13 also only has blocking teeth 28 at the points at which the teeth 31 of the first group of the shift teeth 27 engage. Furthermore, the roof faces 35, 36 of the coupling teeth 30 are designed as asymmetrical in the same manner as the roof faces 33, 34 of the teeth 32 of the second group of the shift teeth 29. However, in this case the front roof face 35 in the miming direction of the shift teeth 27 has a smaller axial extension than the rear roof face 36 of the coupling teeth 30 in the running direction of the shift teeth 32.

FIG. 3A shows the shift teeth 31, 32, blocking teeth 28, and coupling teeth 30 in the neutral position again. In the event of a gear change, as shown in FIG. 3B, only the roof faces 37 of the teeth 31 of the first group of the shift teeth 27, which are used for synchronizing, now come into contact with the blocking faces of the blocking teeth 28. An axial force is thus again exerted on the synchronizing ring 12, 13. The action direction of the axial force is again symbolized by the arrow provided with reference sign 25. The shifting force also simultaneously generates a restoring force on the synchronizing ring 12, 13 via the roof faces 37. The action direction of the restoring force is again symbolized by the arrow provided with reference sign 26. Upon synchronization of the parts, the restoring force predominates over the peripheral force acting on the friction faces and brings the synchronizing ring 12, 13 into a middle position, in which the sleeve 16 can be shifted through.

In this case, as shown in FIG. 3C, the teeth 32 of the second group of the shift teeth 29 are not prevented from axially advancing, since the synchronizing ring does not have blocking teeth 28 at the points at which the teeth 32 of the second group of the shift teeth 29 engage. If the teeth 32 of the second group of the shift teeth 29 now come into contact with the coupling teeth 30, a possible momentum of the clutch gearing 14, 15 on the gear wheel only acts, as shown in FIG. 3D, on the clutch sleeve 16, in the case of a renewed differential speed of both parts because of excessively slow shifting or excessively high viscosity of the transmission oil, in the rotational direction of the two parts, without a rejection of the clutch sleeve 16 occurring.

Simultaneously, the asymmetrical design of the roof faces 33, 34, 35, 36 of the teeth 32 of the second group of the shift teeth 29 and the coupling teeth 30 has the effect that they can easily slide past one another, as shown in FIG. 3E, when they strike one another because of the different rotational direction conditions. FIG. 3F again shows the state in which the teeth 32 of the second group of the shift teeth 29 are completely engaged in the coupling teeth 14, 15 and therefore the gear wheel 4, 5 associated with the gear to be shifted is coupled to the shaft 2.

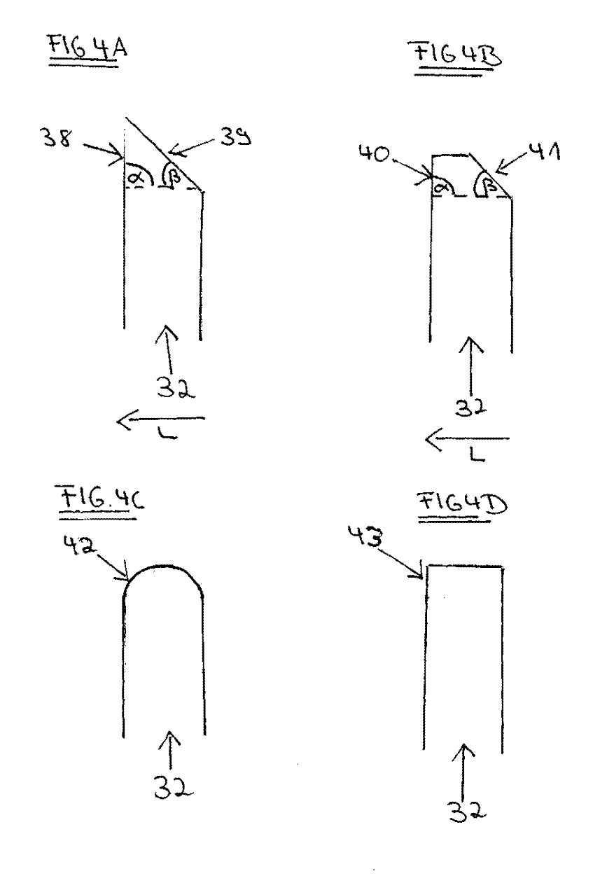

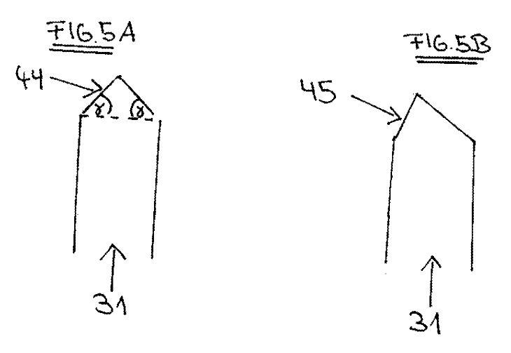

FIG. 4A to FIG. 4D show schematic cross sections of the teeth 32 of the second group of the shift teeth 29 according to various embodiments. The roof faces 38, 39, 40, 41 of the teeth 32 of the second group of the shift teeth 29 can be designed as triangular 38, 39, as shown in FIG. 4A, or as trapezoidal 40, 41, as shown in FIG. 4B. The front roof face 38, 40 in the running direction of the teeth 32 of the second group of the shift teeth 29 has a different roof angle than the rear roof face 40, 42 in the running direction. The running direction of the shift teeth 27 is again symbolized by the arrow provided with reference sign L.

The roof angle α of the front roof face 38, 40 in the running direction is approximately 0° to approximately 20°. In the exemplary embodiments shown, the roof angle α of the front roof face in the running direction is approximately 0°. It is thus ensured that a possible momentum of the coupling teeth 14, 15 on the gear wheel only acts on the clutch sleeve 16, in case of a further differential speed between shift teeth 17 and coupling teeth 14, 15 because of an excessively slow shift or excessively high viscosity of the transmission oil, for example, in the rotational direction of the two parts, without a rejection of the clutch sleeve 16 occurring.

Furthermore, the roof angle β of the rear roof face 39, 41 in the running direction is approximately 45°. It is thus ensured that the roof faces 38, 39, 40, 41 of the teeth 32 of the second group of the shift teeth 29 and the coupling teeth 30 can easily slide past one another, which are preferably designed asymmetrically in the same manner, whereby the downshifting or upshifting is also not impaired or worsened. Furthermore, the roof faces 42, 43 of the teeth 32 of the second group of the shift teeth 29 can also be designed as round 42, as shown in FIG. 4C, or as rectangular 43, as shown in FIG. 4D.

FIG. 5A and FIG. 5B show schematic cross sections of the teeth 31 of the first group of the shift teeth 27 according to different embodiments. As shown in FIG. 5A, the roof faces 44 of the teeth 31 of the first group of the shift teeth 27 can be designed as symmetrical. The roof angle χ of the symmetrical roof faces 45 of the shift teeth is approximately 45° to approximately 60°. In the exemplary embodiment shown, the roof angle χ is approximately 45°. Through such a design, the teeth 31 of the first group of the shift teeth 27, which are exclusively provided for synchronizing, can be designed optimally for their function. Furthermore, the roof faces 45 of the teeth 31 of the first group of the shift teeth 27 can also be designed as asymmetrical, as shown in FIG. 5B.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A clutch sleeve for a shift clutch having a synchronizing device, comprising:
coupling teeth
blocking teeth;
a first group of shift teeth; and
a second group of shift teeth,
wherein the first group of shift teeth and the second group of shift teeth are configured such that the first group of shift teeth cooperates with the blocking teeth until a synchronized speed is reached and the second group of shift teeth engages in the coupling teeth after the synchronized speed is reached.

2. The clutch sleeve for a shift clutch according to claim 1,
wherein the second group of shift teeth is oriented to engage in the coupling teeth, and
wherein the first group of shift teeth cooperates with the blocking teeth.

3. The clutch sleeve for a shift clutch according to claim 1, wherein the first group of shift teeth rotates further at a substantially similar speed as the second group of shift teeth, while the second group of shift teeth engages in the coupling teeth.

4. The clutch sleeve for a shift clutch according to claim 1, wherein first teeth of the first group of shift teeth are axially shorter than second teeth of the second group of shift teeth.

5. The clutch sleeve for a shift clutch according to claim 1, wherein roof faces of the second teeth of the second group of shift teeth are asymmetrical.

6. The clutch sleeve for a shift clutch according to claim 1, wherein roof faces of the second teeth of the second group of shift teeth are triangular.

7. The clutch sleeve for a shift clutch according to claim 6, wherein a front roof face in a running direction comprises a different roof angle than a rear roof face in the running direction.

8. The clutch sleeve for a shift clutch according to claim 7, wherein the roof angle of the front roof face in the running direction is approximately 0° to approximately 20°.

9. The clutch sleeve for a shift clutch according to claim 7, wherein the roof angle of the rear roof face in the running direction is approximately 45°.

10. The clutch sleeve for a shift clutch according to claim 1, wherein roof faces of the second teeth of the second group of shift teeth are rectangular.

11. The clutch sleeve for a shift clutch according to claim 1, wherein roof faces of the first teeth of the first group of shift teeth are symmetrical.

12. The clutch sleeve for a shift clutch according to claim 11, wherein a roof angle of the symmetrical roof faces of the first teeth is approximately 45° to approximately 60°.

13. The clutch sleeve for a shift clutch according to claim 1, wherein the roof faces of the first teeth of the first group of shift teeth are asymmetrical.

14. The clutch sleeve for a shift clutch according to claim 1, wherein the second teeth of the second group of shift teeth are axially advanced in relation to the first teeth of the first group of shift teeth on the clutch sleeve.

15. A shift clutch having a synchronizing device, comprising:
a gear wheel;
a clutch body connected in a rotationally-fixed manner to the gear wheel mounted to rotate on a shaft;
coupling teeth;
a friction cone;
a synchronizing ring comprising a counter cone and blocking teeth; and
a clutch sleeve comprising:
coupling teeth;
blocking teeth;
a first group of shift teeth; and
a second group of shift teeth,
wherein the first group of shift teeth and the second group of shift teeth are configured such that the first group of shift teeth cooperates with the blocking teeth until a synchronized speed is reached and the second group of shift teeth engages in the coupling teeth after the synchronized speed is reached,
wherein the synchronizing ring only has blocking teeth at the points at which the teeth of the first group of the shift teeth engage.

16. The shift clutch according to claim 15,
wherein the second group of shift teeth is oriented to engage in the coupling teeth, and
wherein the first group of shift teeth cooperates with the blocking teeth.

17. The shift clutch sleeve according to claim 15, wherein the first group of shift teeth rotates further at a substantially similar speed as the second group of shift teeth, while the second group of shift teeth engages in the coupling teeth.

18. The clutch sleeve according to claim 15, wherein first teeth of the first group of shift teeth are axially shorter than second teeth of the second group of shift teeth.

19. The clutch sleeve for a shift clutch according to claim 1, wherein roof faces of the second teeth of the second group of shift teeth are trapezoidal.

20. The clutch sleeve for a shift clutch according to claim 1, wherein roof faces of the second teeth of the second group of shift teeth are round.
